(19) United States
(12) Patent Application Publication
(10) Pub. No.: US 2009/0157734 A1
(43) Pub. Date: Jun. 18, 2009

(54) DYNAMICALLY GENERATED MVC BASED USER INTERFACE

(76) Inventor: Zubair Khan, New York, NY (US)

Correspondence Address: MEREDITH & KEYHANI, PLLC, 330 MADISON AVE., 6TH FLOOR, NEW YORK, NY, 10017, US

(21) Appl. No.: 12/336,211

(22) Filed: Dec. 16, 2008

Related U.S. Application Data
(60) Provisional application No. 61/014,469, filed on Dec. 18, 2007.

(51) Int. Cl. G06F 17/30

(52) U.S. Cl. 707/102; 707/E17.009

(57) ABSTRACT

An apparatus comprising a storage medium with instructions stored when executed causing a processing device to perform: parsing a nonexecutable XML Schema file by the apparatus to provide at least one empty dynamic in-memory object representing the application code for the parsed nonexecutable XML Schema file; providing media specific code tangibly embodied in a computer readable medium for a specified media according to the at least one empty dynamic in-memory objects; translating the media specific code for the specified media back to the dynamic in-memory objects to provide at least one populated dynamic object; storing the at least one populated dynamic object to provide ORM based application code tangibly embodied in a computer readable medium; and creating a relational database table associated with and storing at least one item of ORM based application code.

This application claims priority to and is a continuing application of provisional application 61/014,469 filed Dec. 18, 2007 entitled “Dynamically generated MVC based user interface” which is incorporated by reference.

The present invention relates to methods and systems for dynamically creating a plurality of workflow user interfaces by reading XML Schema file(s) (XSD) in its entirety with referenced namespaces to quickly generate a workflow application.

The term workflow is used in computer programming to capture, develop and streamline human to machine interaction. Workflow software aims to provide end users with an easier way to orchestrate or describe complex processing of data in a visual form, much like flow charts but without the need to understand computers or programming. Many software systems exist to support workflows in particular domains. Such systems manage tasks such as automatic routing, partially automated processing and integration between different functional software applications and hardware systems that contribute to the value-addition process underlying the workflow.

Businesses have typically built business/workflow applications from scratch by designing the screens and then programming the screens as part of the work flow. Each screen is specifically coded separately and then integrated with the rest of the application. This is a very tedious and repetitive process that some customer relationship management (CRM) systems have been trying to optimize but it still takes some time to customize, update and maintain these CRM systems.

Accordingly, the present invention provides method and systems for dynamically creating a plurality of workflow user interfaces by reading XML Schema file(s) (XSD) in its entirety with referenced namespaces and generating a workflow application on the fly. Based on the information expressed in the XSD file, the method parses the XSD file with its relationships, legal building blocks, shared vocabularies, constraints (rules made by people, the structure, content and semantics which are all typically used for validation purposes, and creates a user interface together with dynamic objects with connectivity to persistence servers (database, file, external system). The method also retrieves old information and stores the new information back on the server or integrates the information with an external system with the option of serializing the objects. The method also validates the information gathered against the base Schema.

These and other features, aspects and advantages of the present invention will become better understood with reference to the following description and claims.

### SUMMARY OF THE INVENTION

The present invention relates generally to integrated business solutions in a computing environment and in particular methods and systems for dynamically creating a plurality of workflow user interfaces by reading XML Schema file(s) (XSD) in its entirety with referenced namespaces to quickly generate a workflow application.

According to one embodiment of the present invention, a computer processor implemented method of generating object relational mapping (ORM) based application code tangibly embodied in a computer readable medium, the method comprising the steps of: providing a nonexecutable XML Schema file from a specific application tangibly embodied in a computer readable medium;

parsing the nonexecutable XML Schema file by a computer processor to provide at least one empty dynamic in-memory object representing the application code for the parsed nonexecutable XML Schema file, wherein the at least one empty dynamic in memory object is tangibly embodied in a computer readable media; providing media specific code tangibly embodied in a computer readable medium for a specified media according to at least one empty dynamic in-memory objects; translating the media specific code for the specified media back to the dynamic in-memory objects to provide at least one populated dynamic object; and storing the at least one populated dynamic object to provide ORM based application code tangibly embodied in a computer readable medium.

According to another embodiment of the present invention, an apparatus comprising a storage medium with instructions stored therein, the instructions when executed causing a processing device to perform: parsing a nonexecutable XML Schema file by the apparatus to provide at least one empty dynamic in-memory object representing the application code for the parsed nonexecutable XML Schema file, wherein the at least one empty dynamic in memory object is tangibly embodied in a storage media; providing media specific code tangibly embodied in a computer readable medium for a specified media according to the at least one empty dynamic in-memory objects; translating the media specific code for the specified media back to the dynamic in-memory objects to provide at least one populated dynamic object; storing the at least one populated dynamic object to provide ORM based application code tangibly embodied in a computer readable medium; and creating a relational database table associated with and storing at least one item of ORM based application code.

These and other features, aspects and advantages of the present invention will become better understood with reference to the following description and claims.

### BRIEF DESCRIPTION OF THE DRAWINGS

FIG. 1 depicts a computing environment according to the present invention;

FIG. 2 depicts a model view controller architecture according to the present invention;

FIGS. 3a-3b depict a method according to the present invention; and

FIG. 4 depicts the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

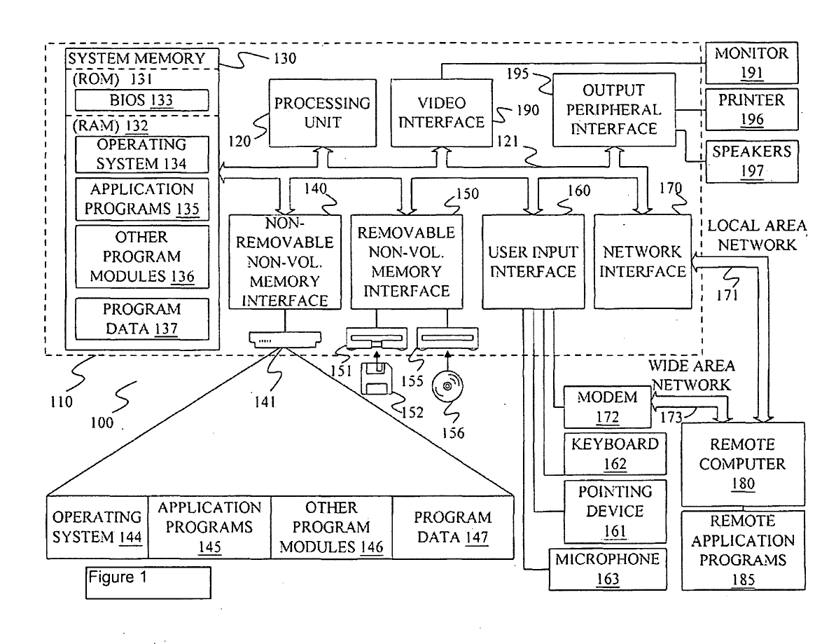

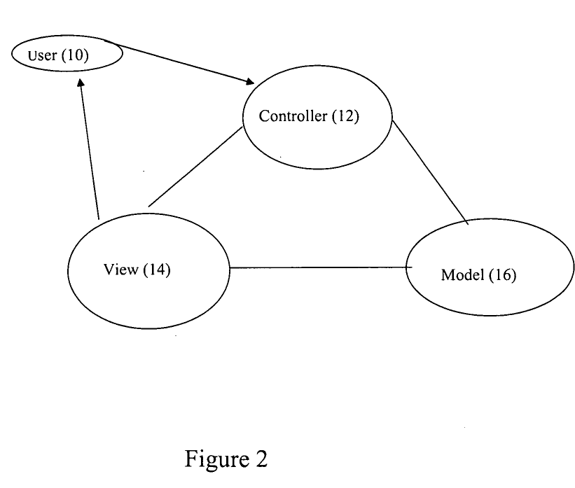

FIG. 1 provides one example of a computing system environment 100 as in the present invention. This is one example of a typical computing system environment 100 and not intended to limit the invention. The components depicted and described in FIG. 1 are not required and should not be interpreted as creating dependency on their presence, but are provided by way of example to depict one example of a computing system. Other computing systems environments and configurations may be hand held devices, laptop devices, mobile phones, personal computers, server computers, micro-processor based systems, network PCs, distributed computing environments that include any of the above systems or device and additional systems or devices not listed as would be appreciated by those of skill in the art.

The apparatus comprising a storage medium as in the present invention, according to one embodiment, is a computer 110. The computer 110 may include a processing unit 120, a system memory 130 and a system bus 121 that couples various systems components including the system memory to the processing unit 120. The system bus 121 may be, by way of example, a memory bus or memory controller, peripheral bus, local bus using bus architecture or any bus structure known within the art. Examples of bus architectures may be Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

A computer 110 as in the present invention includes a variety of computer readable media that may be accessed including volatile and nonvolatile media, removable and non-removable media implemented in any method or technology for storage of information such as computer readable instructions, program modules, data structures or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage medium. By way of example only, FIG. 1 illustrates examples of storage medium such as a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage medium that may be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. For natural user interface applications, a user may further communicate with the computer using speech, handwriting, gaze (eye movement), and other gestures. To facilitate a natural user interface, a computer may include microphones, writing pads, cameras, motion sensors, and other devices for capturing user gestures. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

The present invention relates to systems and methods for dynamically creating a plurality of workflow user interfaces by reading XML Schema file(s) (XSD) in its entirety with referenced namespaces to generate a workflow application on the fly. A Model View Controller (MVC) architectural design pattern is utilized which enables the construction and design of applications and interfaces that work in different specified media (such as phones, webpages, emails). FIG. 1 provides a MVC architecture. As can be seen the user (10) may view (14) an interface such as user interfaces, clients, portals, reporting, and the controller (12). The model (16) maintains data, the views (14) display all or a portion of the data and the controller (12) handles events that affect the model or view. Based on the information expressed in the XSD file, the method parses the XSD file with its relationships, legal building blocks, shared vocabularies, constraints (rules made by people, the structure, content and semantics which are all typically used for validation purposes, and creates a user interface together with dynamic objects with connectivity to persistence servers (database, file, external system). The method also retrieves old information and stores the new information back on the server or integrates the information with an external system with the option of serializing the objects. The method also validates the information gathered against the base Schema.

The present invention provides, an apparatus comprising a storage medium with instructions stored therein. The storage medium may be hard disk drive 141 or it may be a storage medium on a remote computer 180 or a remote server (which could be a remote computer 180). The instructions when executed causing a processing device to perform: parsing a nonexecutable XML Schema file by the apparatus to provide at least one empty dynamic in-memory object representing the application code for the parsed nonexecutable XML Schema file, wherein the at least one empty dynamic in memory object is tangibly embodied in a storage media; providing media specific code tangibly embodied in a computer readable medium for a specified media according to said at least one empty dynamic in-memory objects; translating the media specific code for the specified media back to said dynamic in-memory objects to provide at least one populated dynamic object; storing the at least one populated dynamic object to provide ORM based application code tangibly embodied in a computer readable medium; and creating a relational database table associated with and storing at least one item of ORM based application code. The database storage may be done using the ORM layer which in turn loops through the node elements (properties) of the dynamic object and creates SQL statements and executes them on the database to store, update or retrieve the relevant (mapped using object name and database table name) data.

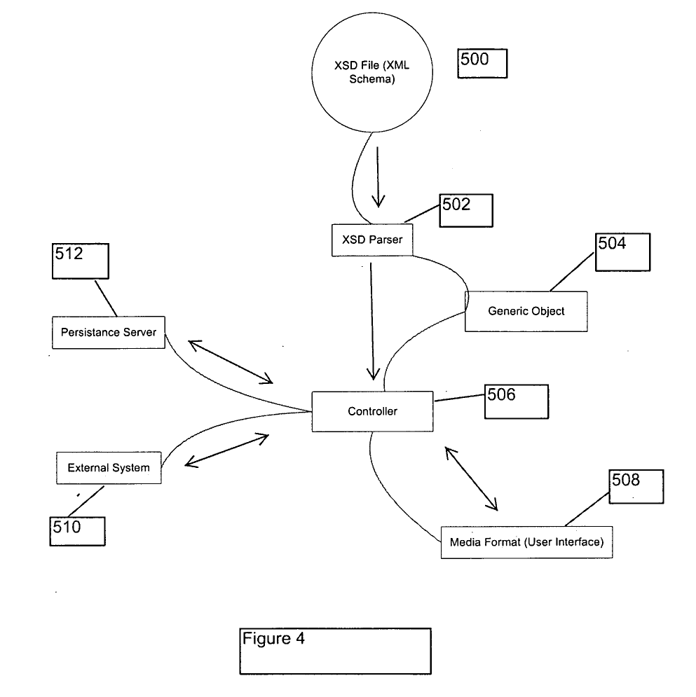

The dynamic in-memory objects may be stored in a database according to a desired persistence. As depicted in FIG. 4, there may be an XSD File (500) having XML schema, this defines how the data should appear in an XML document and is used for data gathering. The File goes to the XSD parser (502) which reads the XML Schema with namespaces creating Dynamic Objects from each component of the definition and typically includes cardinality, restrictions, etc. There may also be a generic object (504) representing each component of the schema (business object). The controller (506) coordinates between all components or actions and gets the parser to return objects. The persistence server (512) may be either a database of file system and would store information. There may also be an external system (510) that can accept XML of other formats as well as system objects for faster processing. There is also a media format user interface (508) which may be web based, phone, or any other application. The dynamic in-memory objects may be stored by transmitting to an external system as a message. The Sending/Receiving of an XML message may be done using SOAP (simple object access protocol) which embodies the data in an envelope sent to the desired external system. The data in the envelope is valid XML (per schema) populated by looping through the designed elements/properties of the dynamic objects.

The instructions when executed may cause a processing device to perform the steps of: translating between a first media specific code and a second media code; sending the first media specific code to the user's browser in the form of HTML to provide first media specific HTML code; extracting information from said first media specific HTML code; populating the first media specific HTML code in an ORM object; and mapping the ORM object to a database table in relational form to provide a second media code. [028]

The nonexecutable XML Schema file may be further comprising the namespaces that it extends. The parsed nonexecutable XML Schema file may be further comprising structure and processing information.

The user may be provided with a user interface with XML schema displayed on a user interface, wherein the XML Schema has at least two tree nodes each tree node having at least one element and at least one level of child nodes and the user may actuate a tree node to display at least one child node populated with related data. XML schema may have many nodes (elements inside a complex type), where each node may recursively have many child nodes. A user might edit any node in the tree at any time. An example structure might look like this: A human can have two eyes, can have 0-many hair, and 0-many children. This tree can go on recursively. This is an example of structure which can be edited. Processing language may contain Regular Expressions validating an edit by a user, or instructions on how to determine the value of the node. For example to get it from a specific file or a specific column in a specified database table. There may be the step of accepting an edit by a user of the element of the node; and saving the edit in a database. Also, there may be the step of ensuring the edit is valid prior to saving the edit in a database.

There may be the step of extracting data from the database; converting the data from the database into XML which is schema valid to provide schema valid XML; and sending the schema valid XML to at least one external system.

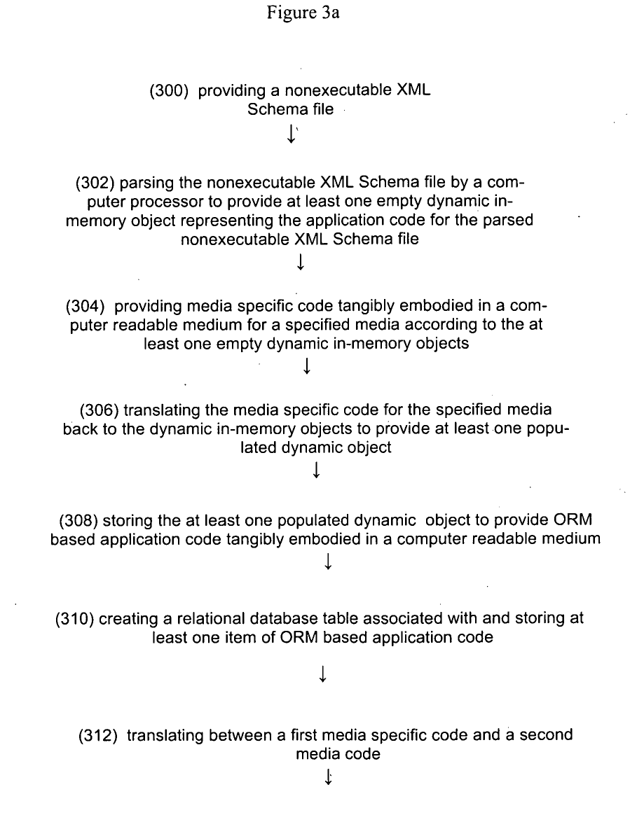

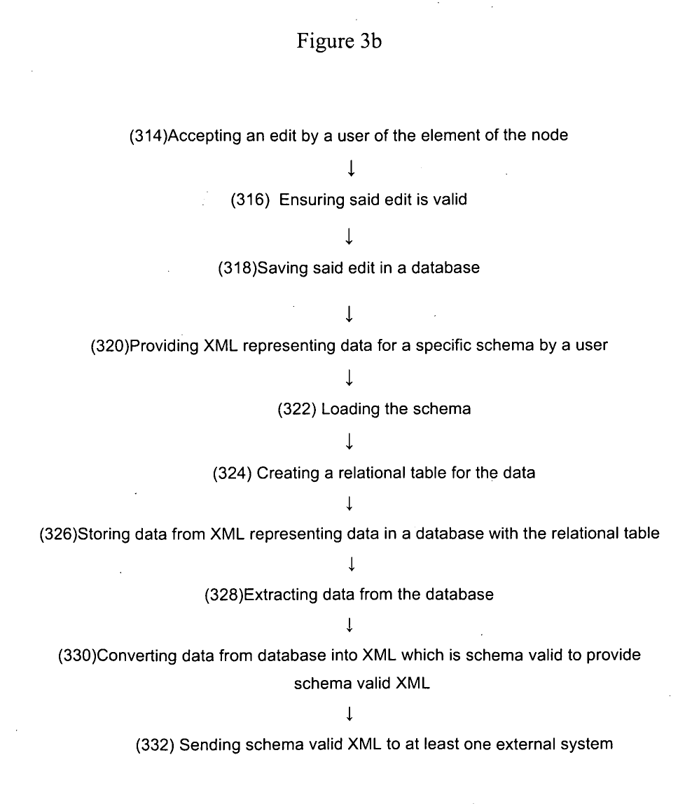

The present invention, as depicted in FIGS. 3a and 3b, also provides a computer processor implemented method of generating ORM based application code tangibly embodied in a computer readable medium, the method comprising the steps of: (300) providing a nonexecutable XML Schema file from a specific application tangibly embodied in a computer readable medium; (302) parsing the nonexecutable XML Schema file by a computer processor to provide at least one empty dynamic in-memory object representing the application code for the parsed nonexecutable XML Schema file, wherein the at least one empty dynamic in memory object is tangibly embodied in a computer readable media; (304) providing media specific code tangibly embodied in a computer readable medium for a specified media according to the at least one empty dynamic in-memory objects; (306) translating the media specific code for the specified media back to the dynamic in-memory objects to provide at least one populated dynamic object; and (308) storing the at least one populated dynamic object to provide ORM based application code tangibly embodied in a computer readable medium. There may be the steps of (310) creating a relational database table associated with and storing at least one item of ORM based application code.

The step of storing said dynamic in-memory objects may be stored according to a desired persistence. The step of storing the dynamic in-memory objects is transmitted to an external system as a message. The media specific code may be selected from the group consisting of XML, SQL, XHTML, XFORM and HTML.

There may be the step of (312) translating between a first media specific code and a second media code, which may be performed by sending the first media specific code to the user's browser in the form of HTML to provide first media specific HTML code; extracting information from the first media specific HTML code; populating the first media specific HTML code in an ORM object; and mapping the ORM object to a database table in relational form to provide a second media code.

The step of parsing the nonexecutable XML Schema file to provide at least one parsed nonexecutable XML Schema file may be further comprising the namespaces that it extends. The step of parsing the nonexecutable XML Schema file to provide at least one parsed nonexecutable XML Schema file may also be further comprising structure and processing information.

There may be the step of providing a user with a user interface with XML schema displayed on a user interface, wherein the XML Schema has at least two tree nodes each tree node having at least one element and at least one level of child nodes and the user may actuate a tree node to display at least one child node populated with related data. There may the step of (314) accepting an edit by a user of the element of the node; and (318) saving the edit in a database. It may be desirable to perform the step of (316) ensuring the edit is valid prior to saving the edit in a database.

There may also be the step of (320) providing XML representing data for a specific schema by a user; (322) Loading the schema; (324) creating a relational table; (326) storing the data from the XML representing data in a database with the relational table.

There may also be the steps of (328) extracting data from the database; (330) converting the data from the database into XML which is schema valid to provide schema valid XML; and (332) sending the schema valid XML to at least one external system.

It should be understood that the foregoing relates to preferred embodiments of the invention and that modifications may be made without departing from the spirit and scope of the invention as set forth in the following claims.

I claim:

1. A computer processor implemented method of generating ORM based application code tangibly embodied in a computer readable medium, said method comprising the steps of:
providing a nonexecutable XML Schema file from a specific application tangibly embodied in a computer readable medium;
parsing said nonexecutable XML Schema file by a computer processor to provide at least one empty dynamic in-memory object representing the application code for said parsed nonexecutable XML Schema file, wherein said at least one empty dynamic in memory object is tangibly embodied in a computer readable media;
providing media specific code tangibly embodied in a computer readable medium for a specified media according to said at least one empty dynamic in-memory objects;
translating said media specific code for said specified media back to said dynamic in-memory objects to provide at least one populated dynamic object; and
storing said at least one populated dynamic object to provide ORM based application code tangibly embodied in a computer readable medium.

2. A computer processor implemented method as in claim 1, further comprising the step of:
creating a relational database table associated with and storing at least one item of ORM based application code.

3. A computer processor implemented method as in claim 1, wherein said step of storing said dynamic in-memory objects is stored according to a desired persistence.

4. A computer processor implemented method as in claim 1, wherein said step of storing said dynamic in-memory objects is transmitted to an external system as a message.

5. A computer processor implemented method as in claim 1, wherein said media specific code is selected from the group consisting of XML, SQL, XHTML, XFORM and HTML.

6. A computer processor implemented method as in claim 1, further comprising the step of:
translating between a first media specific code and a second media code.

7. A computer processor implemented method as in claim 6, wherein said step of translating is further comprising the steps of:
sending said first media specific code to the user's browser in the form of HTML to provide first media specific HTML code;
extracting information from said first media specific HTML code;
populating said first media specific HTML code in an ORM object; and
mapping said ORM object to a database table in relational form to provide a second media code.

8. A computer processor implemented method as in claim 1, wherein said step of parsing said nonexecutable XML Schema file to provide at least one parsed nonexecutable XML Schema file is further comprising the namespaces that it extends.

9. A computer processor implemented method as in claim 1, wherein said step of parsing said nonexecutable XML Schema file to provide at least one parsed nonexecutable XML Schema file is further comprising structure and processing information.

10. A computer processor implemented method as in claim 1, further comprising the steps of:
Providing a user with a user interface with XML schema displayed on a user interface, wherein said XML Schema has at least two tree nodes each tree node having at least one element and at least one level of child nodes and said user may actuate a tree node to display at least one child node populated with related data.

11. A computer processor implemented method as in claim 10, further comprising the steps of:
Accepting an edit by a user of said element of said node;
Saving said edit in a database.

12. A computer processor implemented method as in claim 11, further comprising the steps of:
Ensuring said edit is valid prior to saving said edit in a database.

13. A computer processor implemented method as in claim 10, further comprising the steps of:
Providing XML representing data for a specific schema by a user;
Loading said schema;
Creating a relational table for said data;
Storing said data from said XML representing data in a database with said relational table.

14. A computer processor implemented method as in claim 13, further comprising the steps of:
Extracting data from said database;
Converting said data from said database into XML which is schema valid to provide schema valid XML; and
Sending said schema valid XML to at least one external system.

15. An apparatus comprising a storage medium with instructions stored therein, the instructions when executed causing a processing device to perform:
parsing a nonexecutable XML Schema file by said apparatus to provide at least one empty dynamic in-memory object representing the application code for said parsed nonexecutable XML Schema file, wherein said at least one empty dynamic in memory object is tangibly embodied in a storage media;
providing media specific code tangibly embodied in a computer readable medium for a specified media according to said at least one empty dynamic in-memory objects;
translating said media specific code for said specified media back to said dynamic in-memory objects to provide at least one populated dynamic object;
storing said at least one populated dynamic object to provide ORM based application code tangibly embodied in a computer readable medium; and
creating a relational database table associated with and storing at least one item of ORM based application code.

16. An apparatus as in claim 15, wherein said dynamic in-memory objects are stored in a database according to a desired persistence.

17. An apparatus as in claim 15, wherein said dynamic in-memory objects are stored by transmitting to an external system as a message.

18. An apparatus as in claim 15, the instructions when executed causing a processing device to perform:
translating between a first media specific code and a second media code.
sending said first media specific code to the user's browser in the form of HTML to provide first media specific HTML code;
extracting information from said first media specific HTML code;
populating said first media specific HTML code in an ORM object; and
mapping said ORM object to a database table in relational form to provide a second media code.

19. An apparatus as in claim 15, wherein said nonexecutable XML Schema file is further comprising the namespaces that it extends.

20. An apparatus as in claim 15, wherein said said parsed nonexecutable XML Schema file is further comprising structure and processing information.

21. An apparatus as in claim 15, further causing a processing device to perform:
Providing a user with a user interface with XML schema displayed on a user interface, wherein said XML Schema has at least two tree nodes each tree node having at least one element and at least one level of child nodes and said user may actuate a tree node to display at least one child node populated with related data.

22. An apparatus as in claim 15, further causing a processing device to perform:
Accepting an edit by a user of said element of said node;
Saving said edit in a database.

23. An apparatus as in claim 15, further causing a processing device to perform:
Ensuring said edit is valid prior to saving said edit in a database.

24. An apparatus as in claim 15, further causing a processing device to perform:
Extracting data from said database;
Converting said data from said database into XML which is schema valid to provide schema valid XML; and
Sending said schema valid XML to at least one external system.
